(19) United States
(12) Patent Application Publication
(10) Pub. No.: US 2014/0181996 A1
(43) Pub. Date: Jun. 26, 2014

(54) COMPUTER READABLE STORAGE MEDIUM FOR STORING APPLICATION PROGRAM FOR NETWORK CERTIFICATION

(71) Applicant: COMPAL ELECTRONICS, INC., Taipei City (TW)

(72) Inventors: Chih-Chien LIU, Taipei City (TW); Yi-Chang CHEN, Taipei City (TW); Chih-Hsing KANG, TAIPEI (TW)

(73) Assignee: COMPAL ELECTRONICS, INC., Taipei City (TW)

(21) Appl. No.: 13/851,111

(22) Filed: Mar. 27, 2013

(30) Foreign Application Priority Data
Dec. 25, 2012 (TW) 101149831

(51) Int. Cl. H04L 29/06

(52) U.S. Cl. CPC H04L 63/10
USPC 726/29

(57) ABSTRACT

The present invention discloses a computer readable storage medium for storing an application program for network certification. The application program is implemented by an electrical device to execute a network certification process. The network certification process includes the following steps: a network module of the electrical device is driven to receive a certification code, which is broadcasted by a network access point (AP). Determine if the certification code is in an identified list. When the certification code is not in the identified list, the application program executes an action to limit communication between the electrical device and the network AP.

### Related Applications

This application claims priority to Taiwan Application Serial Number 101149831, filed Dec. 25, 2012, which is herein incorporated by reference.

### BACKGROUND

1. Technical Field

The present invention relates to a computer readable storage for storing an application program for network certification.

2. Description of Related Art

With the rapid development of computer-communication-consumer (3C) industry, electrical devices are more frequently used as assisting tools of our daily life. For examples, the popular electrical devices may include personal digital assistants (PDAs), mobile phones, smart phones, notebook (NB) and computers, etc. To attract the increasing amount of the consumers of the electrical devices, a wide variety of functions are developed. However, along with the popularity of the electrical devices and their more and more compact design, the stolen electrical devices are also increasingly reported.

As a result, there is a need to prevent an electrical device from being stolen in the art.

### SUMMARY

According to one embodiment of this invention, a computer readable storage medium for storing an application program for network certification is disclosed. The application program is implemented by an electrical device to execute a network certification process. The network certification process includes the following steps: a network module of the electrical device is driven to receive a certification code, which is broadcasted by a network access point (AP). Determine if the certification code is in an identified list. When the certification code is not in the identified list, the application program executes an action to limit communication between the electrical device and the network AP.

The present invention can achieve many advantages. When the electrical device applying the present invention is taken away from the area served by the network AP in the identified list, the electrical device cannot perform all supported functions. In addition, the network AP is usually disposed in a fixed position, which can not be moved easily, and the certification code of the network AP can not be stolen or reproduced easily after being encrypted by a security key. Accordingly, the network certification process of the present invention can be used in the Ethernet network or wireless network, and may not be broken easily by stealing or reproducing the certification code. Furthermore, others may not want to seal the electrical device applying the present invention.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram of a network certification process according to one embodiment of this invention; and

FIG. 2 illustrates a block diagram of an electrical device according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

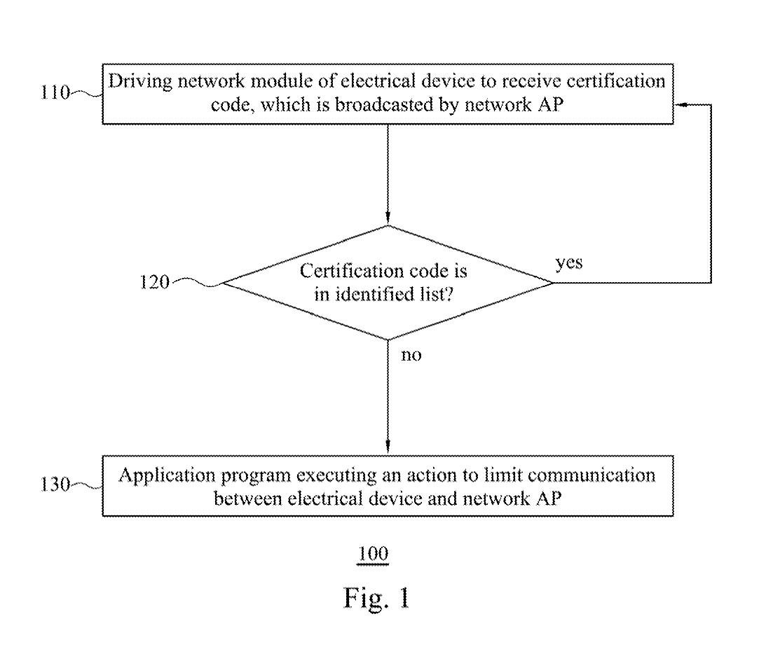

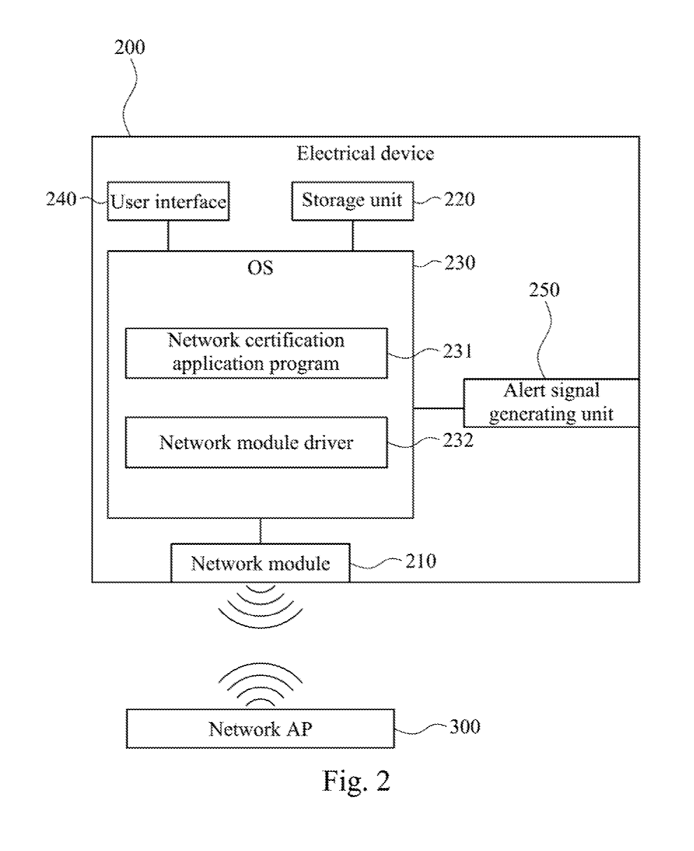

According to one embodiment of this invention, a computer readable storage medium for storing an application program for network certification is disclosed. The application program is implemented by an electrical device to execute a network certification process. Any suitable storage medium (such as medium) may be used. For example, suitable storage medium can be non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); or magnetic storage devices such as hard disk drives (HDD) and floppy disk drives. In this invention, the network certification process is suitable used in the Ethernet network or wireless network. FIG. 1 is a flow diagram of a network certification process according to one embodiment of this invention. FIG. 2 illustrates a block diagram of an electrical device according to one embodiment of this invention. Please refer to both FIG. 1 and FIG. 2.

When an electrical device 200 is located in a wireless network and reads a computer readable storage medium of an embodiment of this invention, a network certification application program 231, which is stored in the computer readable storage medium, is loaded into an operating system (OS) 230 of the electrical device 200, such that the electrical device 200 executes a network certification process 100. Wherein, the OS 230 is executed by a processing unit of the electrical device 220. The network certification process 100 includes the following steps:

At step 110, a network module 210 of the electrical device 200 is driven to receive a certification code, which is broadcasted by a network access point (AP) 300. The network access point (AP) 300 may be a wireless access point (WAP). Wherein the electrical device 200 may utilize a network module driver 232, which is installed in the OS 230, to drive its network module 210 to perform the receiving function at step 110. The network module 210 may be a wireless network card or any other hardware able to receive the certification code broadcasted by the network AP 300. In some embodiments, a Service Set Identifier (SSID) of the network AP 300 may be taken as the certification code for the network module 210 of the electrical device 200 to receive. In addition, the certification code may be any other type of certification code broadcasted by the network AP 300.

At step 120, determine if the certification code is in an identified list. In some embodiments, the identified list may be pre-stored in a storage unit 220 of the electrical device 200.

At step 130, when the certification code is not in the identified list, the application program 230 executes an action to limit communication between the electrical device 200 and the network AP 300. Hence, when the electrical device 200 cannot receive the certification code in the identified list, the electrical device 200 may execute limited functions. When the electrical device 200 is taken away from the area served by the network AP 300 in the identified list, the electrical device 200 cannot perform all supported functions. In addition, the network AP 300 is usually disposed in a fixed position, which cannot be moved easily, and the certification code of the network AP 300 cannot be stolen or reproduced easily after being encrypted by a security key. Accordingly, the network certification process 100 may not be broken easily by stealing or reproducing the certification code.

Moreover, when the certification code is not in the identified list, the application program 231 may further drive an alert signal generating unit 250 of the electrical device 200 to generate an alert signal. The alert signal may be a light signal, a sound signal or any other type of alert signal. Therefore, the alert signal may stop others from stealing the electrical device 200.

When the certification code is in the identified list, the network module 210 of the electrical device 200 may keep receiving the certification code broadcasted by the network AP 300.

In some embodiments of this invention, the network certification process 100 may further include the following steps: the application program 230 is utilized to drive the electrical device 200 to provide a user interface 240. Hence, a user can edit the identified list stored in the storage unit 220 through the user interface 240. Subsequently, an edit signal corresponding to the edit operation can be received through the user interface 240. The electrical device 200 edits the identified list according to the edit signal. In addition, a user can input a password through the user interface 240 to switch the electrical device 200 from the limited function mode to an un-limited function mode.

In some embodiments of this invention, the application program 231 may be utilized to disable actions of the electrical device 200, such that the communication between the electrical device 200 and the network AP 300 can be limited at step 130.

In some other embodiments of this invention, the application program 231 to drive the electrical device 200 to stop accessing the network provided by the network AP 300.

In some other embodiments of the network certification process 100, when the electrical device 200 is initiated, the electrical device 200 is triggered to execute the application program 231 to start to drive the network module 210 to receive the certification code. Therefore, the network certification process 100 can be triggered once the electrical device 200 is initiated.

The present invention can achieve many advantages. When the electrical device applying the present invention is taken away from the area served by the network AP in the identified list, the electrical device cannot perform all supported functions. In addition, the network AP is usually disposed in a fixed position, which can not be moved easily, and the certification code of the network AP can not be stolen or reproduced easily after being encrypted by a security key. Accordingly, the network certification process of the present invention can be used in the Ethernet network or wireless network, and may not be broken easily by stealing or reproducing the certification code. Furthermore, others may not want to seal the electrical device applying the present invention.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A computer readable storage medium for storing an application program for network certification, the application program being implemented by an electrical device to execute a network certification process, the network certification process comprising the steps of:
driving a network module of the electrical device to receive a certification code, which is broadcasted by a network access point (AP);
determining if the certification code is in an identified list; and
when the certification code is not in the identified list, the application program executing an action to limit communication between the electrical device and the network AP.

2. The computer readable storage medium of claim 1, wherein the certification code is a Service Set Identifier (SSID) of the network AP.

3. The computer readable storage medium of claim 1, wherein the network certification process further comprises the steps of:
utilizing the application program to drive the electrical device to provide a user interface;
receiving an edit signal through the user interface; and
editing the identified list according to the edit signal.

4. The computer readable storage medium of claim 1, wherein the step of limiting the communication between the electrical device and the network AP comprises the step of:
utilizing the application program to disable actions of the electrical device.

5. The computer readable storage medium of claim 1 wherein the step of limiting the communication between the electrical device and the network AP comprises the step of:
utilizing the application program to drive the electrical device to stop accessing the network.

6. The computer readable storage medium of claim 1, wherein the network certification process further comprises the step of:
when the certification code is not in the identified list, utilizing the application program to drive the electrical device to generate an alert signal.

7. The computer readable storage medium of claim 6, wherein the alert signal is a light signal or a sound signal.

8. The computer readable storage medium of claim 1, wherein the network certification process further comprises the step of:
when the electrical device is initiated, triggering the electrical device to implement the application program to start driving the network module to receive the certification code.
